(19) United States
(12) Patent Application Publication
(10) Pub. No.: US 2002/0191879 A1
(43) Pub. Date: Dec. 19, 2002

(54) Switchable wavelength filter

(76) Inventors: Wen-fung Liu, Taipei (TW); Chih-Chung Yang, Taipei (TW); Ding-Wei Huang, Taipei (TW)

Correspondence Address: RABIN & CHAMPAGNE, PC, 1101 14TH STREET, NW, SUITE 500, WASHINGTON, DC, 20005, US

(21) Appl. No.: 10/127,417

(22) Filed: Apr. 23, 2002

(30) Foreign Application Priority Data
Jun. 18, 2001 (TW) 090114779

(51) Int. Cl. G02F 1/335; G02B 6/34

(52) U.S. Cl. 385/7; 385/37

(57) ABSTRACT

A fiber-optic switchable wavelength filter comprises a fiber grating positioned in the thin section of the fiber, a horn with the tip attached to the side of the fiber, and a piezoelectric transducer fixed to the bottom of the horn. Upon receiving a voltage signal, the piezoelectric transducer can create acoustic wave in the horn, wherein the amplitude of the acoustic vibration in the horn is controlled by the magnitude of the voltage signal. The vibration energy is transferred and focused from the horn to the fiber, such that the operation wavelength is switched by changing the reflectivity of the optical signal at the Bragg wavelength and the reflectivity of the optical signal at the cladding-mode coupling wavelength.

This application incorporates by reference Taiwanese application Serial No. 90114779, filed Jun. 18, 2001.

### BACKGROUND OF THE INVENTION

1. Field of the Invention

This invention relates to an optically switchable wavelength filter, particularly to a fiber-optic switchable wavelength filter of switching the wavelength of reflection by utilizing the fiber grating and triggering acoustic waves.

2. Description of the Related Art

Recently, there have been rapid developments in the communication industry, particularly, in fiber-optic technologies. The optical fiber has been widely used because it offers high volume of transmission and low loss of transmission. The technology of wavelength division multiplexing (WDM) achieves simultaneous multi-channel transmission in a fiber for increasing the volume of data transmitted, and thus, receives much attention. In the WDM system, the optical switch is an important apparatus. Therefore, it is worthwhile to research how to make use of the optical fiber as the function of an optical switch or a switchable wavelength filter.

Nowadays, it is universally known that using the optical fiber grating and acoustic waves can adjust the reflectivity of the fiber Bragg grating. First, the fiber is exposed by a UV laser using a phase-mask-writing technology for periodically refractive index changes along the fiber axis. Then a voltage is applied to a piezoelectric transducer to produce the acoustic waves for triggering the transverse vibration in the fiber. Accordingly, the reflectivity at the Bragg wavelength is then adjusted by controlling the amplitude of the transverse vibration. However, the process described above can only induce the reflectivity variation at a single wavelength and the wavelength of reflection cannot be switched if there is no other appropriate designation.

### SUMMARY OF THE INVENTION

The object of this invention is to improve the design and operation condition for the switchable wavelength filter described above and to switch one operation wavelength to the other wavelength by using both the fiber grating and acoustic waves. The relative intensity of signals at different wavelengths is controlled by the applied voltage levels, and the acoustic-optic coupling efficiency can be improved by the outer diameter of the cladding in the proximity of the fiber grating. The switchable wavelength filter of the present invention can be applicable in wavelength division multiplexed (WDM) systems of optical fiber communication.

The switchable wavelength filter of the present invention comprises a fiber for transmitting and reflecting optical signals at different wavelengths. The fiber comprises a fiber grating in the middle part, which is etched to form a thin section. A horn is positioned near the thin section, and the tip of the horn is attached to the side of the fiber. A piezoelectric transducer is glued to the bottom of the horn as an acoustic wave source. Upon receiving a voltage signal, the piezoelectric transducer produces acoustic waves in the horn, and the acoustic vibration is transferred from the horn to the fiber, to trigger the transverse vibration of the fiber, which produces micro-bending in the fiber. Then, the core mode signal is coupled to the cladding and the cladding mode signal is coupled back to the fiber core, which causes the attenuation of the optical signal at the Bragg wavelength and the increment of the optical signal at the cladding-mode coupling wavelength. Therefore, the switching function from one reflected wavelength to another reflected wavelength is accomplished.

### BRIEF DESCRIPTION OF THE DRAWINGS

The above objects and other advantages of the present invention will become apparent from the detailed description of the preferred embodiment of the present invention, with reference to the attached drawings in which:

FIG. 1 shows the framework for the switchable wavelength filter capable of switching the wavelength of reflection according to one embodiment of the present invention;

FIGS. 2A-2C show the transmission variation when an optical signal at the Bragg wavelength λ_{B} passes through the switchable wavelength filter of FIG. 1 without applying the voltage signal;

FIGS. 3A-3C show the transmission variation when an optical signal at the Bragg wavelength λ_{B} passes through the switchable wavelength filter of FIG. 1 when the voltage signal is applied;

FIGS. 4A-4C show the transmission variation when an optical signal at the cladding-mode coupling wavelength λₛ passes through the switchable wavelength filter of FIG. 1 without applying the voltage signal;

FIGS. 5A-5C show the transmission variation when an optical signal at the cladding-mode coupling wavelength λₛ passes through the switchable wavelength filter of FIG. 1 when the voltage signal is applied;

FIGS. 6A-6D show the reflection spectra of the optical signal according to the different voltage values applied to the fiber switchable wavelength filter; and

FIG. 7 shows the relationship between the reflectivity and the applied voltage for the optical signal at the Bragg wavelength λ_{B} and the optical signal at the cladding-mode coupling wavelength λₛ.

### DESCRIPTION OF THE PREFERRED EMBODIMENTS

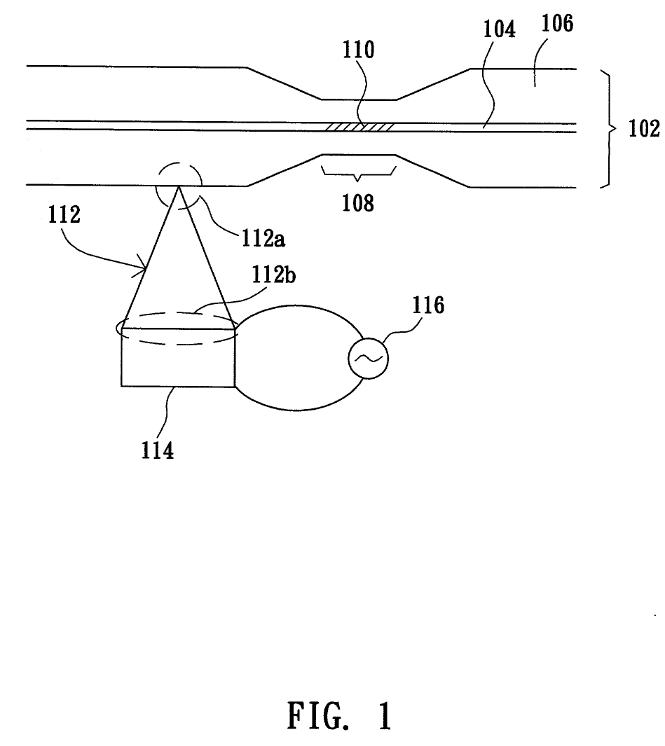

Referring to FIG. 1, it shows the framework for the switchable wavelength filter capable of switching the wavelength of reflection according to one embodiment of the present invention. Generally, the fiber 102 consists of a core 104 in the center of the fiber 102 and a cladding 106 covering the core 104. The fiber 102 comprises a thin section 108 and a fiber grating 110 in the core 104 of the thin section 108, for adjusting the reflectivity of the optical signal at the wavelength of λ_{B}. In the proximity of the thin section 108, the fiber 102 is connected to a horn 112, which comprises a tip 112A attached to the fiber 102 and the bottom 112B is linked with the piezoelectric transducer 114, which is used to produce the acoustic wave.

As the piezoelectric transducer 114 is connected with the voltage source 116, the voltage signal from the voltage source 116 will drive the piezoelectric transducer 114 to create a vibration, which is an acoustic wave and is transferred to the bottom 112B of the horn. The horn 112 is used for concentrating the acoustic wave energy, transferred from the piezoelectric transducer 114 to the tip 112A of the horn. The horn tip 112A is connected to the side of fiber 102 and therefore, the concentrated acoustic wave energy is transferred to the fiber 102. Accordingly, the transverse vibration and the corresponding micro-bending of the fiber 102 are produced. The transverse vibration of the fiber, a flexural wave, will propagate along the axis of the fiber 102, wherein the vibration frequency is equal to the frequency of the voltage signal with alternating current supplied from the voltage source 116 and the vibration intensity is proportional to the amplitude of the signal from the voltage source 116.

The optical signal switched by the fiber 102 comprises a singal at the Bragg wavelength λB (first wavelength) and a signal at the cladding-mode coupling wavelength λₛ (second wavelength). The Bragg wavelength λ_{B} is determined by the period of fiber grating 110 and the effective refractive index of the core of the fiber 102. The cladding-mode coupling wavelength λₛ is related to the diameter of the thin section 108, the fiber type and the frequency of the voltage signal with alternating current from the power source 116.

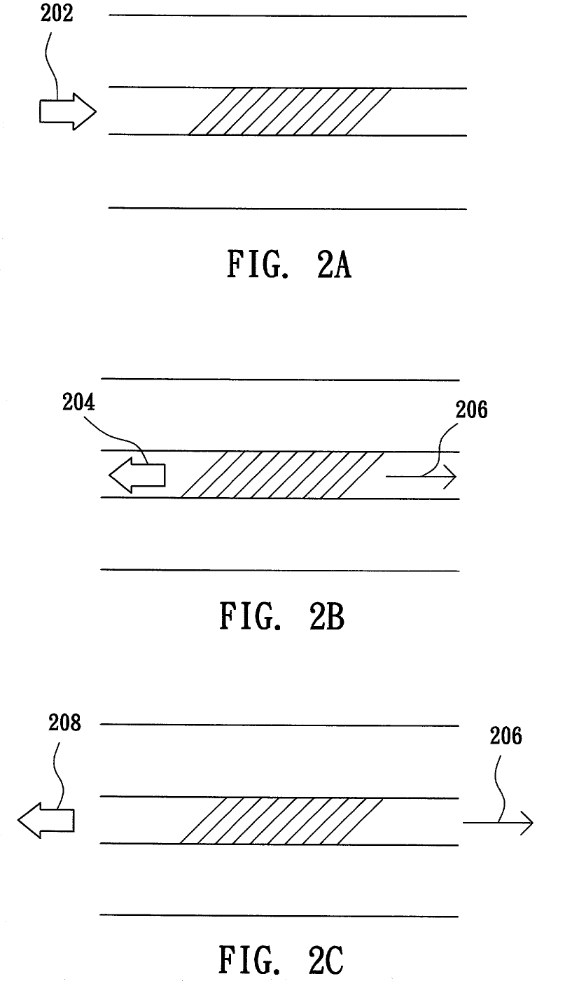

Referring to FIGS. 2A through 2C, they show the transmission variation when an optical signal at the Bragg wavelength λ_{B} passes through the switchable wavelength filter of FIG. 1 without applying the voltage signal. FIG. 2A shows the transmission condition before the optical signal at the Bragg wavelength λ_{B} arrives at the fiber grating 110, according to the forward-propagating core mode. The optical signal at the Bragg wavelength λ_{B} propagates in the core 104, as indicated by the arrow 202. FIG. 2B shows the condition when the optical signal at the Bragg wavelength λ_{B} is reflected in the fiber grating 110. As the optical signal at the Bragg wavelength λ_{B} propagates to the fiber grating 110, in the case of phase matching, most of the optical signal is reflected because of the coupling between the forward-propagating core mode and the backward-propagating core mode, as indicated by the arrow 204, and a small part of the optical signal at the Bragg wavelength λ_{B} propagates through the fiber grating in the positive direction according to the forward-propagating core mode, as indicated by the arrow 206. FIG. 2C shows the condition after the optical signal at the Bragg wavelength λ_{B} passes through the fiber grating 110. Most of the optical signal at the Bragg wavelength λ_{B} is reflected and propagates in the opposite direction, in the fiber 102, as indicated by the arrow 208, and a small part of the optical signal at the Bragg wavelength λ_{B} propagates in the positive direction.

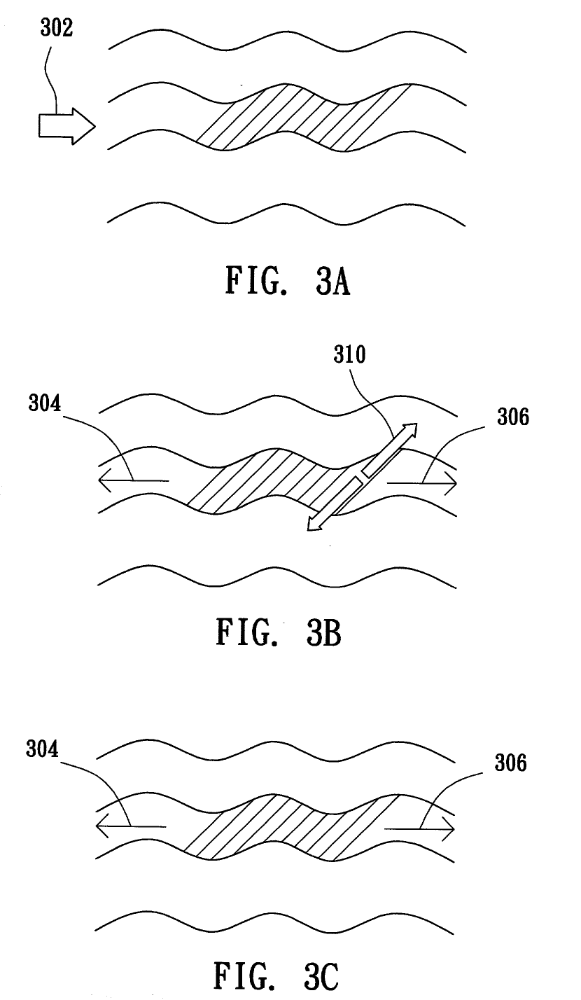

Referring to FIGS. 3A through 3C, they show the transmission variation when the optical signal at the Bragg wavelength λ_{B} passes through the switchable wavelength filter of FIG. 1 with applying the voltage signal. FIG. 3A shows the transmission condition before the optical signal at the Bragg wavelength λ_{B} arrives at the fiber grating 110, according to the forward-propagating core mode. The optical signal at the Bragg wavelength λ_{B} propagates in the core 104, as indicated by the arrow 302. Next, FIG. 3B shows the condition when the optical signal at the Bragg wavelength λ_{B} is reflected in the fiber grating 110. The voltage signal induces the transverse vibration in the fiber 102, and therefore causes micro-bending of the fiber. The micro-bending phenomenon excited from the transverse vibration triggers the phase matching, wherein the optical signal at the Bragg wavelength λ_{B} couples to the cladding 106, as indicated by the arrow 310. And the optical signal of Bragg wavelength λ_{B} coupled to the backward-propagating core mode is attenuated, as indicated by the arrow 304, while the optical signal of Bragg wavelength λ_{B} coupled to the forward-propagating core mode is also reduced, as indicated by the arrow 306. FIG. 3C shows the condition after the optical signal at the Bragg wavelength λ_{B} passes through the fiber grating 110. Most of the reflected energy at the Bragg wavelength λ_{B} is reduced due to the coupling between the core mode and the cladding mode 106. And a small part of the optical signal at the Bragg wavelength λ_{B} propagates in the opposite direction in the fiber 102, as indicated by the arrow 304. Yet another small part of the optical signal at the Bragg wavelength λ_{B} propagates in the positive direction in the core 104, as indicated by the arrow 306. Comparing FIG. 2C and FIG. 3C, the acoustic wave applied from the voltage source 116 will attenuate the intensity of the optical signal at the Bragg wavelength λ_{B} propagating in the opposite direction, in the core 104 of the fiber 102. Therefore, the reflectivity of the optical signal in FIG. 2C at the Bragg wavelength λ_{B} is reduced to that of the optical signal in FIG. 3C.

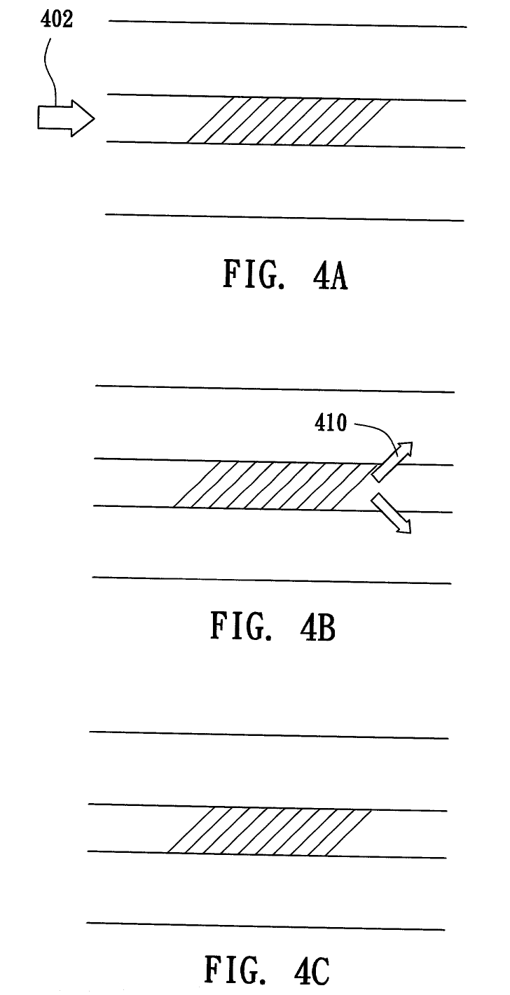

Referring to FIGS. 4A through 4C, they show the transmission variation when the optical signal at the cladding-mode coupling wavelength λₛ passes through the switchable wavelength filter of FIG. 1 without applying the voltage signal. FIG. 4A shows the transmission condition before the optical signal at the Bragg wavelength λ_{B} arrives at the fiber grating 110, according to the forward-propagating core mode. The optical signal at the cladding-mode coupling wavelength λₛ propagates in the core 104, as indicated by the arrow 402. FIG. 4B shows the condition when the optical signal at the cladding-mode coupling wavelength λₛ propagates in the fiber grating 110. As the optical signal at the cladding-mode coupling wavelength λₛ is close to the fiber grating 110, phase matching will be triggered, such that most of the optical signal couples to the backward-propagating cladding mode, as indicated by the arrow 410, and only a very small part of the optical signal from the cladding-mode coupling wavelength λₛ couples to the backward-propagating core mode, so that the reflected signal is insignificant. FIG. 4C shows the condition after the optical signal of cladding-mode coupling wavelength λₛ passes through the fiber grating 110. Most of the optical signal of cladding-mode coupling wavelength λₛ is radiated out of the fiber 102.

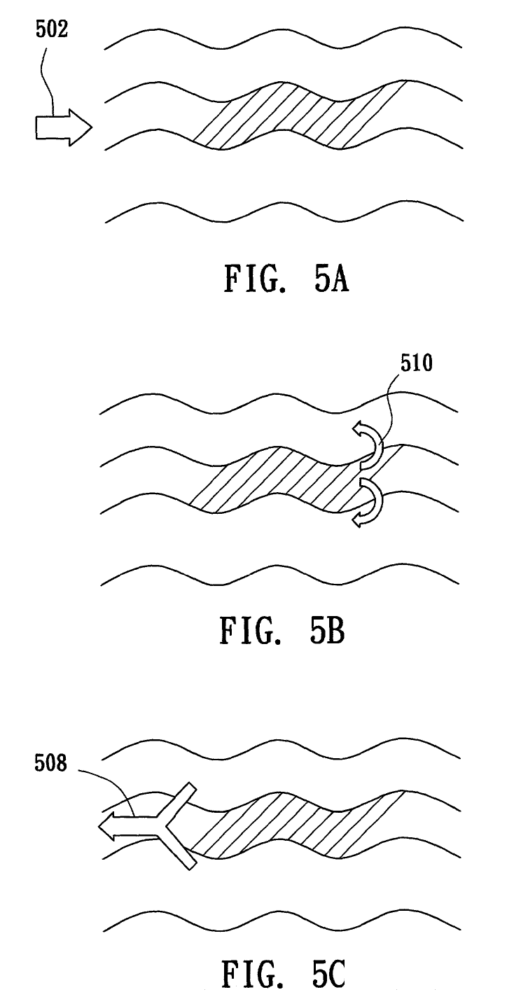

Referring to FIGS. 5A through 5C, they show the transmission variation when the optical signal at the cladding-mode coupling wavelength λₛ passes through the switchable wavelength filter of FIG. 1 with applying the voltage signal. FIG. 5A shows the transmission condition before the optical signal at the cladding-mode coupling wavelength λₛ arrives at the fiber grating 110 according to the forward-propagating core mode. The optical signal at the wavelength λₛ propagates in the core 104, as indicated by the arrow 502. FIG. 5B shows the condition when the optical signal at the wavelength λₛ propagates in the fiber grating 110. Most of the optical signal at the wavelength λₛ couples to the backward-propagating cladding mode, which is the same as that of FIG. 4B and is indicated by the arrow 510. However, in FIG. 5B, the voltage signal will create the transverse vibration of the fiber 102 and induce the coupling of the optical signal at the cladding-mode coupling wavelength λₛ to the core 104, which is different from the coupling shown in FIG. 4B. Thus in FIG. 5C, the optical signal at the cladding-mode coupling wavelength λₛ is coupled from backward-propagating cladding mode to backward-propagating core mode. FIG. 5C shows the condition after the optical signal at the cladding-mode coupling wavelength λₛ passes through the fiber grating 110. Most of the optical signal couples to the backward-propagating core mode and propagates in the opposite direction, as indicated by the arrow 508. Due to the vibration of the fiber 102 excited by the voltage signal in FIG. 5C, the optical signal at the cladding-mode coupling wavelength λₛ, originally coupled to the backward-propagating cladding mode in FIG. 4C, now couples back to the core 104 according to the backward-propagating core mode. Therefore, the optical signal of wavelength λₛ, propagating in the backward-propagating core mode is produced, and the reflectivity of the optical signal at the cladding-mode coupling wavelength λₛ increases by the increment of applying voltage.

From the above description, the fiber vibration excited by the voltage signal will decrease the reflectivity of the optical signal at the Bragg wavelength λ_{B} and increase that of the optical signal at the cladding-mode coupling wavelength λₛ, wherein the quantity of the reflectivity variation is determined by the amplitude of the fiber vibration. Moreover, the outer diameter of the thin section of the fiber determines the acousto-optically coupling efficiency and the wavelength of the optical signal at the cladding-mode coupling wavelength λₛ.

In FIG. 1, the fiber 102 can be a fiber with a single mode fiber, and the horn 112 connected to the fiber 102 can be composed of glass or metal, such as Aluminum material. The horn 112 is used to concentrate the acoustic wave energy, 1.3 M Hz for instance, created from the piezoelectric transducer 114. In order to enhance the micro-bending phenomenon, the cladding 106 of the fiber 102 can be treated with the HF etching liquid, such that the diameter is reduced from 125 μm to about 30 μm and the thin section 108 is formed with a length of about 35 mm. To form the fiber grating 110, the fiber 102 is exposed by the UV laser before the thin section 108 is etched, and the core 104 of the fiber 102 produces periodical variation of the refractive index along the fiber axis. In addition, the fiber grating 110 in the present invention can be a tilt fiber grating with a tilt angle of about 2°˜3°. The length of the fiber grating 110, which is positioned in the center of the thin section 108, is about 17 mm. From the specifications described above, the Bragg wavelength λ_{B} of the switchable wavelength filter is 1541.5 nm and the cladding-mode coupling wavelength λₛ is 1539.7 nm.

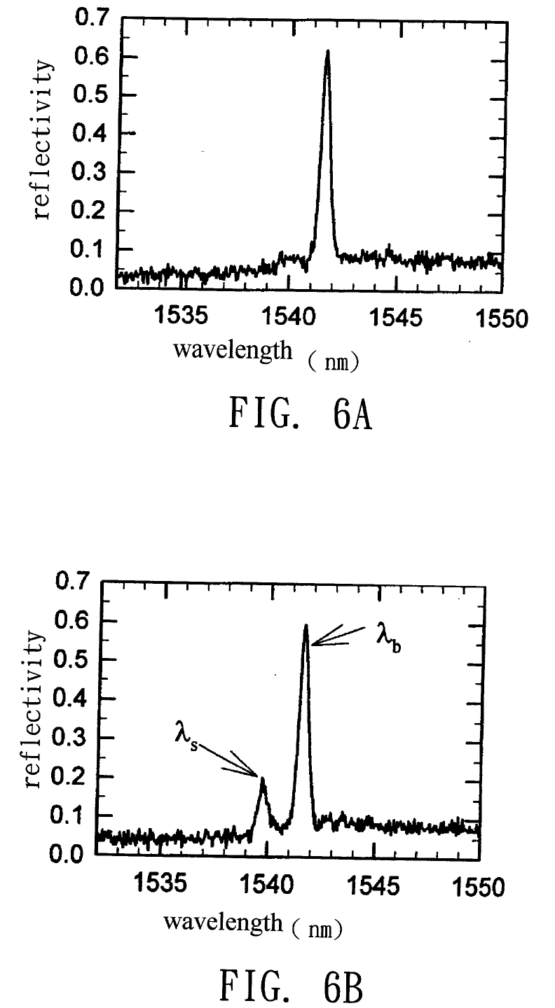

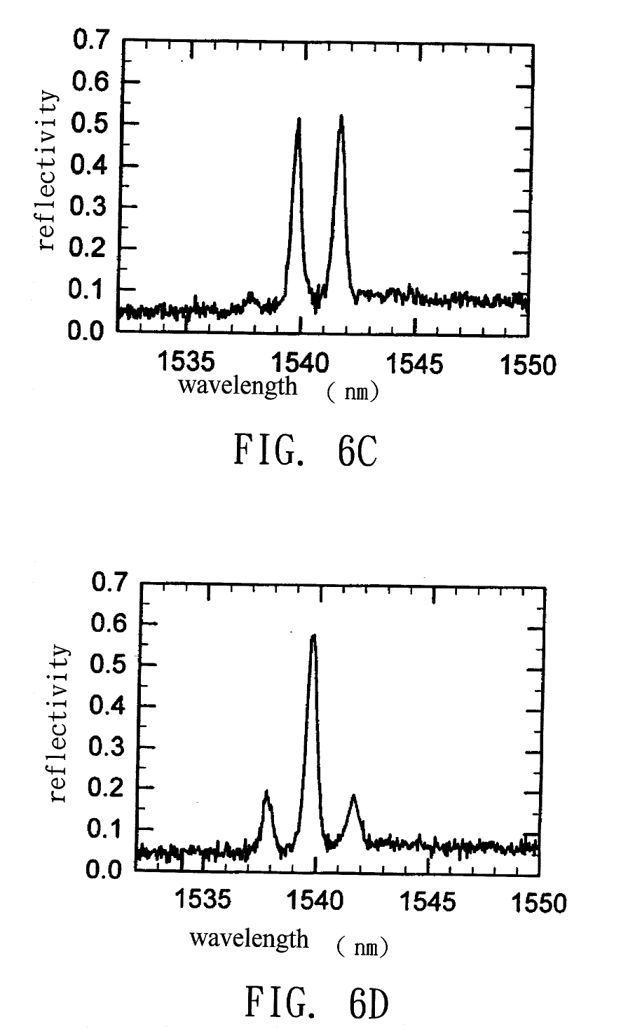

Referring to FIGS. 6A through 6D, they show the reflectivity spectra of the optical signal in relation to voltage levels applied to the switchable wavelength filter. The horizontal axis represents the wavelength of the optical signal and the vertical axis represents the reflectivity. FIG. 6A shows the reflectivity spectrum for the case when there is no voltage applied from the voltage source 116 of FIG. 1. In this condition, only the optical signal at the Bragg wavelength λ_{B} is reflected, at a reflectivity of about 60%, and the optical signal at the cladding-mode coupling wavelength λₛ has no reflectivity. FIG. 6B shows the reflectivity spectrum for the case when a voltage of 1.8 volts is applied. The applied voltage will drive the vibration of piezoelectric transducer 114, and thereby create the transverse vibration amplitude of the fiber 102. Thus the applied voltage decreases the reflectivity of the optical signal at the Bragg wavelength λ_{B} and increases the reflectivity of optical signal at the cladding-mode coupling wavelength λₛ, to about 20%, as shown in FIG. 6B. FIG. 6C shows the reflectivity spectrum for the case when a voltage of 10 volts is applied. The increment in the voltage applied reduces the reflectivity of the optical signal at the Bragg wavelength λ_{B} form 60% to about 50% and raises the reflectivity of optical signal at the cladding-mode coupling wavelength λₛ also to 50%, resulting in a twin-peaked spectrum, as shown in FIG. 6C. When the applied voltage is further raised to 15 volts, the reflectivity spectrum contains one high peak and two low peaks, as shown in FIG. 6D. The reflectivity of the optical signal at the Bragg wavelength λ_{B} drops to about 20%, and the reflectivity of optical signal at the cladding-mode coupling wavelength λₛ increases to about 60%. And yet another optical signal is reflected, with a reflectivity of about 20%, wherein the signal is due to the double-frequency harmonic wave caused by the micro-bending of the fiber and the signal has a shorter wavelength than the cladding-mode coupling wavelength.

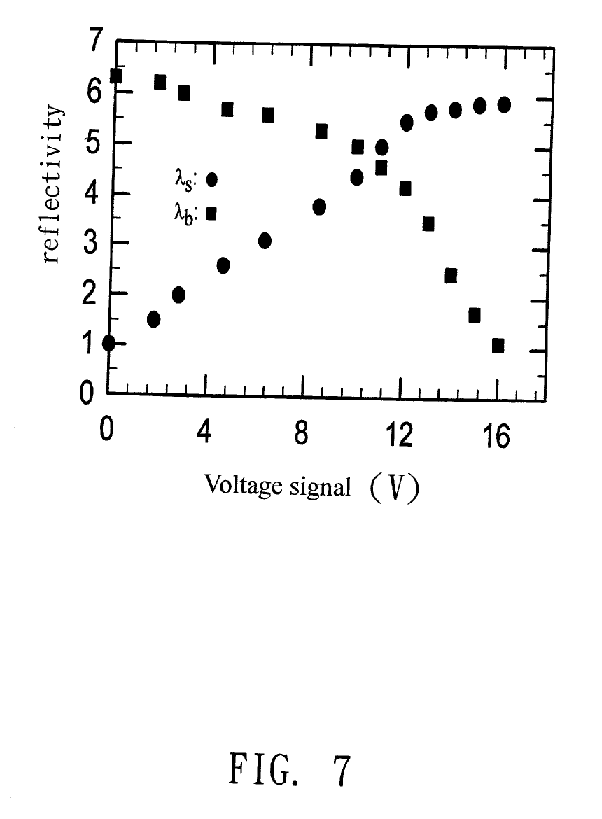

Referring to FIG. 7, it shows the relationship between the reflectivity and the voltage applied in piezoelectric transducer 114 for the optical signal at the Bragg wavelength λ_{B} and the optical signal at the cladding-mode coupling wavelength λₛ. The horizontal axis is the amplitude of the voltage signal with alternating current supplied from the voltage source 116 and the vertical axis is the reflectivity. As the amplitude of the voltage is increased, the reflectivity of optical signal at the Bragg wavelength λ_{B} decreases. However, the reflectivity of optical signal at the cladding-mode coupling wavelength λₛ increases as the voltage amplitude increases. The curve for the optical signal at the Bragg wavelength λ_{B} and the curve for the optical signal at the cladding-mode coupling wavelength λₛ intersect at a voltage of about 10 volts and a reflectivity of about 0.47. Therefore, the wavelength of reflection is changed from λ_{B} to λₛ as the voltage is varied from 0 volt to 16 volts, which is the characteristic of the switchable wavelength filter in the present invention.

In conclusion, the fiber switchable wavelength filter capable of switching the wavelength of reflection disclosed in the present invention is implemented by changing the amplitude of the acoustic vibration. Also used is the fiber grating in the thin section formed by etching the cladding. One operation wavelength is switched into another operation wavelength by adjusting the amplitude of the applied voltage. The position of reflected wavelength and the acousto-optic coupling efficiency are given by the outer diameter of the thin section. The switchable wavelength fiber base on a fiber for the present invention is also applicable for the wavelength division multiplexed add-drop function.

Once given the above disclosure, other features, modifications, and improvements will become apparent to the skilled artisan. Such other features, modifications, and improvements are, therefore, considered to be a part of this invention, and the scope of which is to be determined by the following claims.

What is claimed is:

1. A switchable wavelength filter capable of switching different operation wavelengths comprising:
a fiber for transferring a first optical signal at the first wavelength and a second optical signal at the second wavelength, said fiber comprising a thin section;
a fiber grating positioned in said thin section;
a horn for concentrating and transferring an acoustic vibration to said fiber, said horn comprising a tip attached to the side of said fiber, the reflectivity of said first signal and said second signal transformed by adjusting the amplitude of said acoustic vibration; and
a piezoelectric transducer for receiving a voltage signal and producing said acoustic vibration, said piezoelectric transducer connected to the bottom of said horn.

2. The switchable wavelength filter of claim 1, wherein said fiber grating also includes a tilt fiber grating.

3. The switchable wavelength filter of claim 1, wherein said horn is composed of metal and glass.

4. The switchable wavelength filter of claim 1, wherein said voltage signal is applied from a voltage source.

5. The switchable wavelength filter of claim 1, wherein said first wavelength is a Bragg wavelength.

6. The switchable wavelength filter of claim 1, wherein said second wavelength is a cladding-mode coupling wavelength.
